(19) United States
(12) Patent Application Publication
(10) Pub. No.: US 2014/0096514 A1
(43) Pub. Date: Apr. 10, 2014

(54) DRAIN SYSTEM FOR TORQUE CONVERTER

(71) Applicant: HYUNDAI MOTOR COMPANY, Seoul (KR)

(72) Inventor: Jin Young HWANG, Busan (KR)

(73) Assignee: Hyundai Motor Company, Seoul (KR)

(21) Appl. No.: 13/727,417

(22) Filed: Dec. 26, 2012

(30) Foreign Application Priority Data
Oct. 5, 2012 (KR) 10-2012-0110931

(51) Int. Cl. F16H 41/30

(52) U.S. Cl. CPC F16H 41/30
USPC 60/330

(57) ABSTRACT

A drain system for a torque converter may include a hydraulic drain path draining the oil used in the torque converter to the transmission, a hydraulic control path adapted to transmit the oil discharged out of the hydraulic pump to the hydraulic drain path, and a switch valve disposed at the hydraulic drain path, and adapted to operate by pressure of the oil supplied through the hydraulic control path, wherein the switch valve may selectively open/close the hydraulic drain path.

### CROSS-REFERENCE TO RELATED APPLICATION

The present application claims priority to Korean Patent Application No. 10-2012-0110931 filed on Oct. 5, 2012, the entire contents of which is incorporated herein for all purposes by this reference.

### BACKGROUND OF THE INVENTION

1. Field of the Invention

The present invention relates to a drain system for a torque converter. More particularly, the present invention relates to a drain system for a torque converter in which an amount of oil in the torque converter can be ensured when the engine of the vehicle is stopped.

2. Description of Related Art

Generally, a torque converter amplifies inputted torque by using a fluid and outputs the amplified torque. Herein, the fluid may be oil supplied from a hydraulic pump. In addition, the torque converter amplifies torque of an engine and transmits the amplified torque of the engine to an input shaft of a transmission.

The oil used in the torque converter is drained to the transmission through a hydraulic path disposed in the hydraulic pump. In addition, the hydraulic pump is operated by rotation of the engine. That is, the oil is continuously supplied from the hydraulic pump to the torque converter and drained from the torque converter to the transmission while running the engine. Therefore, a state in which sufficient oil is filled into the torque converter can be maintained while running the engine.

However, the oil is not supplied into the torque converter when the engine is stopped. Further, the oil is naturally drained from the torque converter to the transmission if a state in which the engine is stopped continues. Therefore, the amount oil in the torque converter when the engine is restarted may be insufficient. Meanwhile, an initial launch of the torque converter when the amount of oil is insufficient may be unstable. For example, the launching quality of the torque converter may be deteriorated by a delay of turbine operation, and an impact or excessive vibration may be generated at the torque converter. That is, a driver cannot be satisfied when the engine is started, and the lifespan of the torque converter may be shortened.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a drain system for a torque converter having advantages of preventing oil drainage from the torque converter during a state in which an engine is stopped.

The drain system for a torque converter according to an exemplary embodiment of the present invention is applied to the torque converter which amplifies torque of an engine by using oil supplied from a hydraulic pump operated by torque of an engine and transmits the amplified torque of the engine to an input shaft of a transmission.

In an aspect of the present invention, a drain system for a torque converter, the torque converter amplifying torque of an engine by using oil supplied from a hydraulic pump operated by torque of the engine and transmitting the amplified torque of the engine to an input shaft of a transmission, may include a hydraulic drain path draining the oil used in the torque converter to the transmission, a hydraulic control path adapted to transmit the oil discharged out of the hydraulic pump to the hydraulic drain path, and a switch valve disposed at the hydraulic drain path and adapted to operate by pressure of the oil supplied through the hydraulic control path, wherein the switch valve selectively opens or closes the hydraulic drain path.

The switch valve is operated by hydraulic pressure supplied from the hydraulic pump so as to open the hydraulic drain path.

The switch valve is operated so as to close the hydraulic drain path when operation of the hydraulic pump is stopped.

The switch valve may include a valve body provided with a plurality of ports, a valve spool inserted into the valve body and adapted to slide along a longitudinal direction of the valve body, and an elastic member pushing the valve spool in one direction along the longitudinal direction of the valve body.

The plurality of ports may include an inflow port and an outflow port offset from the inflow port in the longitudinal direction of the valve body.

The valve spool includes a first land and a second land spaced from the first land, wherein the second land selectively closes the outflow port.

The elastic member is mounted on a surface of the second land and biases the valve spool toward a control port formed to the valve body and fluid-connected with the hydraulic pump.

The plurality of ports may include a control port fluid-connected with the hydraulic pump and communicating with the inside of the valve body, wherein hydraulic pressure of oil supplied from the hydraulic pump to the inside of the valve body through the control port pressurizes the valve spool against pressure of the elastic member.

The hydraulic drain path is opened when the valve spool slides against the pressure of the elastic member by the hydraulic pressure of the oil transmitted through the control port.

The hydraulic pressure of the oil transmitted through the control port is released, and the hydraulic drain path is closed according to sliding of the valve spool caused by the elastic member when operation of the hydraulic pump is stopped.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is cross-sectional view of a drain system for a torque converter according to an exemplary embodiment of the present invention.

FIG. 2 is schematic diagram of a state in which a switch valve is opened according to an exemplary embodiment of the present invention.

FIG. 3 is schematic diagram of a state in which a switch valve is closed according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

An exemplary embodiment of the present invention will hereinafter be described in detail with reference to the accompanying drawings.

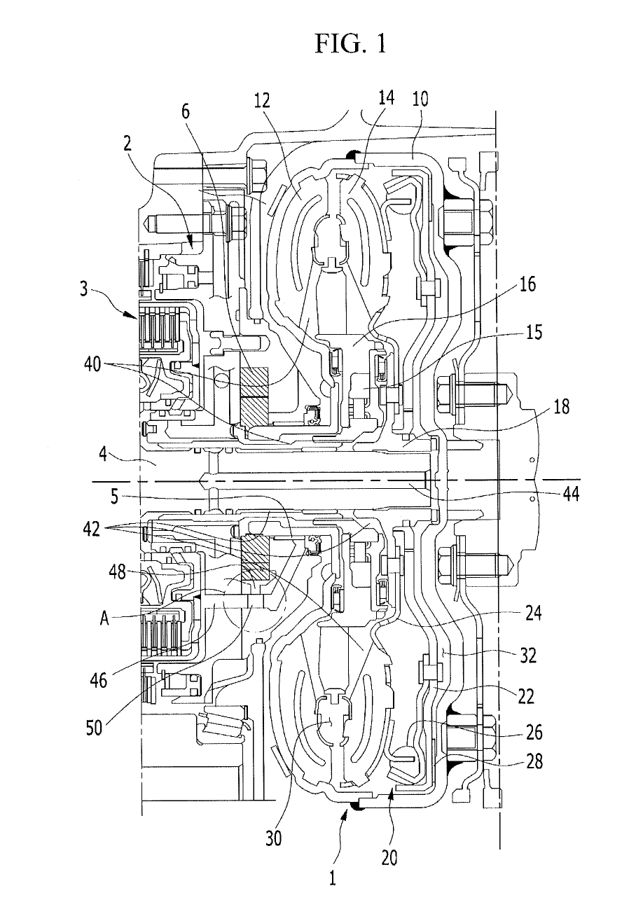

FIG. 1 is cross-sectional view of a drain system for a torque converter according to an exemplary embodiment of the present invention.

As shown in FIG. 1, the drain system for the torque converter according to an exemplary embodiment of the present invention includes a torque converter 1, a hydraulic pump 2, and a transmission 3.

The torque converter 1 includes a cover 10, a pump impeller 12, a turbine runner 14, a stator 16, and a lock-up clutch 20. In addition, the torque converter 1 connects the engine with an input shaft 4 such that power of an engine is transmitted to the transmission 3 through the input shaft 4, and is supplied oil from the hydraulic pump 2.

The cover 10 is a housing in which constituent elements of the torque converter 1 are installed. In addition, the cover 10 is adapted to rotate by torque of the engine. Further, the cover 10 may be directly connected with a crankshaft of the engine so as to integrally rotate with the crankshaft. Meanwhile, one end of the cover 10 is opened such that the input shaft 4 is rotatably inserted therethrough. Herein, the input shaft 4 is an input shaft for transmitting the amplified torque that the torque converter 1 amplifies from the engine to the transmission 3.

The pump impeller 12 is disposed inside of the cover 10. Further, the pump impeller 12 is mounted on one surface of the cover 10 so as to integrally rotate with the cover 10.

The turbine runner 14 is disposed in the cover 10 and faces the pump impeller 12. In addition, the turbine runner 14 is rotated according to torque transmitted from the pump impeller 12 by flow of oil. Further, torque of the turbine runner 14 rotates the input shaft 4. The turbine runner 14 is connected with the input shaft 4 inserted into the cover 10 by a turbine hub 18 so as to integrally rotate together.

The stator 16 is interposed between the pump impeller 12 and the turbine runner 14. Further, the stator 16 has a one-way bearing 15. That is, the stator 16 is rotated in only one direction. In addition, the stator 16 adjusts flow of oil transmitted from the turbine runner 14 and transmits in to the pump impeller 12. The hydraulic pressure of the pump impeller 12 is increased by the operation of the stator 16.

The lock-up clutch 20 is disposed between the turbine runner 14 and the cover 10 on an opposite side to the pump impeller 12 with reference to the turbine runner 14. Further, the lock-up clutch 20 is integrally rotated with the turbine runner 14 and is adapted to selectively couple with the cover 10. Herein, the coupling of the lock-up clutch 20 and the cover 10 is performed by increasing the hydraulic pressure of the pump impeller 12. If the lock-up clutch 20 is coupled with the cover 10, the engine is directly connected with the transmission 3. That is, the transmission 3 rotates at the same speed as the engine.

The constituent elements 10, 12, 14, 16, 18, and 20 of the torque converter 1 are concentrically rotated.

The lock-up clutch 20 includes a clutch piston 22, a damper 24, a coil spring 26, and a friction member 28.

The clutch piston 22 is selectively coupled with the cover 10. A combining chamber 30 is formed between the pump impeller 12 and the turbine runner 14. Further, a separating chamber 32 is formed between the clutch piston 22 and the cover 10. The combining chamber 30 and separating chamber 32 are spaces for forming the hydraulic pressure. In addition, the clutch piston 22 is coupled with the cover 10 when the hydraulic pressure is supplied from the combining chamber 30 to the clutch piston 22. On the contrary, the clutch piston 22 is separated from the cover 10 when the clutch piston 22 the hydraulic pressure is supplied from the separating chamber 32.

The damper 24 is disposed between the clutch piston 22 and the turbine runner 14. In addition, the damper 24 is fixedly connected to the turbine runner 14 and the turbine hub 18. That is, the damper 24 is integrally rotated with the turbine runner 14, the turbine hub 18, and the input shaft 4.

The coil spring 26 is disposed on external circumferences of the clutch piston 22 and the damper 24. In addition, a plurality of the coil springs 26 may be arranged along external circumferences of the clutch piston 22 and the damper 24. Further, the coil spring 26 enables relative rotation of the clutch piston 22 and the damper 24 to be performed in a set range.

The friction member 28 is mounted on one surface of the clutch piston 22. Herein, the one surface of clutch piston 22 is a surface facing the cover 10. In addition, the clutch piston 22 and the cover 10 are coupled to each other and integrally rotated by the friction member 28.

The hydraulic pump 2 is operated by torque of the engine. In addition, the hydraulic pump 2 pumps oil supplied from an oil tank and transmits the oil to the torque converter 1, a lubrication portion, and the transmission 3. The hydraulic pump 2 has a rotor 6, and the rotor 6 is rotated by torque of the engine. Herein, the rotor 6 is a rotor provided to an ordinary hydraulic pump, and the oil is pumped by rotation of rotor 6. The operation of the hydraulic pump 2 by the rotation of the rotor 6 is well-known to a person of ordinary skill in the art, so a detailed description thereof will be omitted.

Further, the operation of the torque converter 1 and the construction of the input shaft 4, the hydraulic pump 2, and the transmission 3 are well-known to a person of ordinary skill in the art such that a detailed description thereof will be omitted.

Hereinafter, supplying oil from the hydraulic pump 2 to the torque converter 1 and draining oil from the torque converter 1 will be described.

The drain system for the torque converter according to an exemplary embodiment of the present invention includes first and second combining passages 40 and 42, a separating passage 44, and a hydraulic drain path 46.

The first combining passage 40 and the second combining passage 42 are adapted to supply oil pumped by the hydraulic pump 2 to the combining chamber 30. That is, the first combining passage 40 and the second combining passage 42 are respectively connected to the hydraulic pump 2.

The first combining passage 40 is formed to sequentially pass through the space between the one opened end of the cover 10 and the input shaft 4 and the space between the pump impeller 12 and the stator 16, and communicates with the combining chamber 30.

The second combining passage 42 is formed to sequentially pass through the space between the one opened end of the cover 10 and the input shaft 4 and the space between the turbine runner 14 and the stator 16, and communicates with the combining chamber 30.

The separating passage 44 is adapted to supply oil pumped by the hydraulic pump 2 to the separating chamber 32. In addition, the separating passage 44 is formed along a longitudinal direction of the input shaft 4 therein such that the hydraulic pump 2 communicates with the separating chamber 32.

The hydraulic drain path 46 is formed in the hydraulic pump 2. A plurality of hydraulic paths may be formed in the hydraulic pump 2 so as to communicate with the torque converter 1 and the transmission 3. That is, the hydraulic drain path 46 is one of the plurality of hydraulic paths formed in the hydraulic pump 2.

The hydraulic drain path 46 drains oil used in the torque converter 1 to the transmission 3. In addition, the oil used in the torque converter 1 lubricates a bush 5 interposed between the one opened end of the torque converter 1 and the hydraulic pump 2 and is then drained to the transmission 3 through the hydraulic drain path 46. Furthermore, the oil exhausted to the transmission 3 lubricates the transmission 3. Herein, the bush 5, which is used for connecting pipes having different diameters from each other, is well-known to a person of ordinary skill in the art such that a detailed description thereof will be omitted.

The hydraulic drain path 46 includes a hydraulic control path 48 and a switch valve 50.

The hydraulic control path 48 is formed such that the hydraulic drain path 46 communicates with the space in which the rotor 6 of the hydraulic pump 2 is disposed. That is, the hydraulic control path 48 is formed in the hydraulic pump 2. In addition, the hydraulic control path 48 is adapted to supply oil discharged from the hydraulic pump 2 to the switch valve 50. In other words, the switch valve 50 is supplied hydraulic pressure from the hydraulic control path 48, the switch valve 50 is operated by the supplied hydraulic pressure. In FIG. 1, the hydraulic control path 48 is formed so as to communicate the hydraulic drain path 46 and the space where the rotor 6 of hydraulic pump 2 is disposed. However, the hydraulic control path 48 is not limited thereto, and can be varied and applied by a person of ordinary skill in the art for transmitting the oil discharged from the hydraulic pump 2 to the hydraulic drain path 46.

The switch valve 50 is provided for selectively exhausting oil from the hydraulic drain path 46. That is, the switch valve 50 selectively opens/closes the hydraulic drain path 46. In addition, the oil used in the torque converter 1 is exhausted to the transmission 3 via the switch valve 50 when the switch valve 50 is operated by the hydraulic pressure supplied from the hydraulic control path 48.

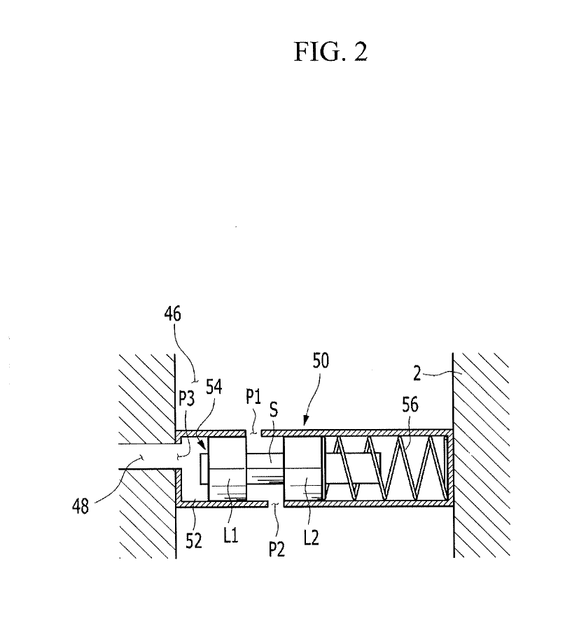

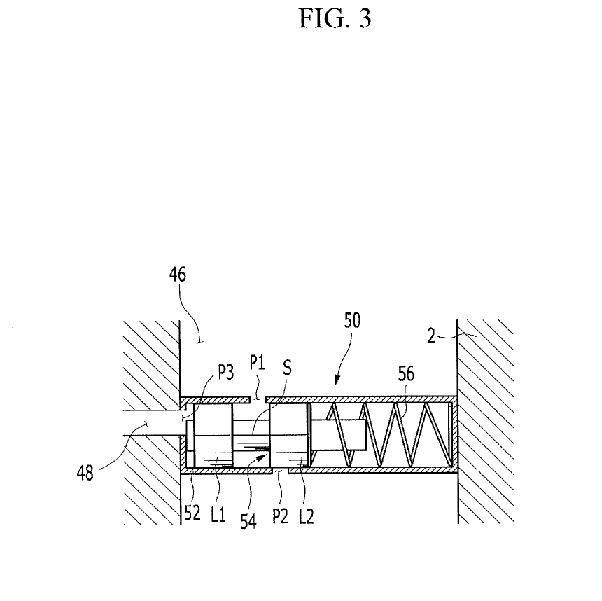

Hereinafter, a construction of the switch valve 50 operated by the hydraulic pressure supplied through the hydraulic control path 48 will be described with reference to FIG. 2 and FIG. 3.

FIG. 2 is schematic diagram of the state in which a switch valve is opened according to an exemplary embodiment of the present invention, and FIG. 3 is schematic diagram of the state in which a switch valve is closed according to an exemplary embodiment of the present invention. That is, FIG. 2 and FIG. 3 are enlarged views of an “A” portion of FIG. 1.

As shown in FIG. 2 and FIG. 3, the switch valve 50 is disposed to open/close the hydraulic drain path 46, and includes a valve body 52, a valve spool 54, and an elastic member 56.

The valve body 52 includes a plurality of ports P1, P2, and P3. The plurality of ports P1, P2, and P3 are formed by penetrating the valve body 52 so as to communicate inside and outside thereof.

The valve spool 54 is inserted into the valve body 52 to be slidable along a longitudinal direction of the valve body 52. In addition, the valve spool 54 has lands L1 and L2 fitted in an inner portion of the valve body 52, and a spool shaft S formed to be substantially thinner than the lands L1 and L2.

The lands L1 and L2 include an operating land L1 and an open/close land L2. In addition, the operating land L1 and the open/close land L2 are connected by the spool shaft S.

The elastic member 56 is disposed between one end of the valve spool 54 and one interior surface of the valve body 52. Herein, the one end of the valve spool 54 may be one end of the open/close land L2. In addition, the elastic member 56 pushes the valve spool 54 in one direction along a longitudinal direction of the valve body 52.

The plurality of ports P1, P2, and P3 include an inflow port P1, an outflow port P2, and a control port P3.

The inflow port P1 communicates with a space between the operating land L1 and open/close land L2. In addition, the oil used in the torque converter 1 flows in through the inflow port P1.

The outflow port P2 is selectively opened or closed according to the sliding of the valve spool 54. Further, the opened outflow port P2 communicates with the space between the operating land L1 and open/close land L2. Therefore, when the outflow port P2 is opened, the oil having flowed into the inflow port P1 is drained through the outflow port P2 via the valve spool 54.

The control port P3 communicates with a space between the other end of the valve spool 54 and the other interior surface of the valve body 52. Herein, the other end of the valve spool 54 may be one end of the operating land L1. In addition, the spool shaft S is protruded by a set length from the one end of the operating land L1 toward the other interior surface of the valve body 52 so as to form the space between the one end of the operating land L1 and the other interior surface of the valve body 52. Further, the control port P3 communicates with the hydraulic control path 48, and the oil discharged from the hydraulic pump 2 flows in the control port P3. The valve spool 54 is pushed by the pressure of the elastic member 56 by hydraulic pressure of the oil having flowed into the control port P3.

The operation of the switch valve 50 will hereinafter be described in detail with reference to FIG. 2 and FIG. 3.

When the hydraulic pump 2 is operated, the oil discharged from the hydraulic pump 2 flows into the valve body 52 through the control port P3. In other words, when the hydraulic pressure generated by pumping of the hydraulic pump 2 is transmitted to the valve body 52 through the hydraulic control path 48 that communicates with the space in which the rotor 6 of the hydraulic pump 2 is disposed, the hydraulic pressure transmitted to the valve body 52 pushes the one end of the operating land L1 and the valve spool 54 slides toward the one interior surface of the valve body 52. In addition, the outflow port P2 is opened by sliding of the valve spool 54. FIG. 2 shows the state in which the valve spool 54 is moved by sliding toward the one interior surface of the valve body 52.

When the operation of the hydraulic pump 2 is stopped, the hydraulic pressure pushing the one end of the operating land L1 is no longer supplied. Thus, the valve spool 54 slides toward the other interior surface of the valve body 52 because of the elastic member 56. That is, the valve spool 54 returns to the original position of before operation. Herein, the elastic member 56 may be a spring. The outflow port P2 is closed according to the valve spool 54 returning to the original position. If the outflow port P2 is closed, draining oil from the torque converter 1 to the transmission 3 is prevented. FIG. 3 shows the state in which the valve spool 54 is moved by sliding toward the other interior surface of the valve body 52.

Meanwhile, the switch valve 50 is operated by the oil discharged from the hydraulic pump 2, and thus does not require any special control unit.

According to the exemplary embodiment of the present invention, draining of oil from the torque converter 1 can be prevented during the state in which the engine is stopped. Therefore, a driver can be satisfied when the engine is started, and the lifespan of the torque converter 1 can be increased.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A drain system for a torque converter, the torque converter amplifying torque of an engine by using oil supplied from a hydraulic pump operated by torque of the engine and transmitting the amplified torque of the engine to an input shaft of a transmission, the system comprising:
a hydraulic drain path draining the oil used in the torque converter to the transmission;
a hydraulic control path adapted to transmit the oil discharged out of the hydraulic pump to the hydraulic drain path; and
a switch valve disposed at the hydraulic drain path and adapted to operate by pressure of the oil supplied through the hydraulic control path,
wherein the switch valve selectively opens or closes the hydraulic drain path.

2. The system of claim 1, wherein the switch valve is operated by hydraulic pressure supplied from the hydraulic pump so as to open the hydraulic drain path.

3. The system of claim 1, wherein the switch valve is operated so as to close the hydraulic drain path when operation of the hydraulic pump is stopped.

4. The system of claim 1, wherein the switch valve includes:
a valve body provided with a plurality of ports;
a valve spool inserted into the valve body and adapted to slide along a longitudinal direction of the valve body; and
an elastic member pushing the valve spool in one direction along the longitudinal direction of the valve body.

5. The system of claim 4, wherein the plurality of ports include an inflow port and an outflow port offset from the inflow port in the longitudinal direction of the valve body.

6. The system of claim 4, wherein the valve spool includes a first land and a second land spaced from the first land, wherein the second land selectively closes the outflow port.

7. The system of claim 6, wherein the elastic member is mounted on a surface of the second land and biases the valve spool toward a control port formed to the valve body and fluid-connected with the hydraulic pump.

8. The system of claim 4, wherein the plurality of ports include a control port fluid-connected with the hydraulic pump and communicating with the inside of the valve body,
wherein hydraulic pressure of oil supplied from the hydraulic pump to the inside of the valve body through the control port pressurizes the valve spool against pressure of the elastic member.

9. The system of claim 8, wherein the hydraulic drain path is opened when the valve spool slides against the pressure of the elastic member by the hydraulic pressure of the oil transmitted through the control port.

10. The system of claim 8, wherein the hydraulic pressure of the oil transmitted through the control port is released, and the hydraulic drain path is closed according to sliding of the valve spool caused by the elastic member when operation of the hydraulic pump is stopped.
